(19) United States
(12) Patent Application Publication
(10) Pub. No.: US 2024/0140275 A1
(43) Pub. Date: May 2, 2024

(54) HEIGHT-ADJUSTMENT APPARATUS FOR A VEHICLE SEAT

(71) Applicant: Brose Fahrzeugteile SE & Co. Kommanditgesellschaft, Coburg, Coburg (DE)

(72) Inventor: Jürgen Schukalski, Küps (DE)

(21) Appl. No.: 18/558,521

(22) PCT Filed: May 2, 2022
(86) PCT No.: PCT/EP2022/061653

§ 371 Date: Nov. 1, 2023

(30) Foreign Application Priority Data
May 4, 2021 (DE) 10 2021 204 486.7

(51) Int. Cl. B60N 2/16

(52) U.S. Cl. CPC B60N 2/164; B60N 2/1615

(57) ABSTRACT

It is provided a height-adjustment apparatus of a vehicle seat comprising a floor assembly, a seat part assembly, a pivot element which is pivotable in relation to the floor assembly and to the seat part assembly, and a drive device which is configured to pivot the pivot element in relation to the floor assembly in order to adjust a seat height of the seat part assembly, wherein the drive device comprises a spindle, a drive motor, and an adjustment gearing which is operatively connected to the spindle and can be driven by the drive motor. The spindle is pivotally connected to the floor assembly, and the adjustment gearing is pivotally arranged on the pivot element.

### BACKGROUND

The proposed solution to a height-adjustment apparatus for a vehicle seat.

A height-adjustment apparatus of this kind comprises a floor assembly, a seat part assembly, and a pivot element which is pivotable relative to the floor assembly and to the seat part assembly. A drive device is configured to pivot the pivot element in relation to the floor assembly in order to adjust a seat height of the seat part assembly, wherein the drive device comprises a spindle, a drive motor, and an adjustment gearing which is operatively connected to the spindle and can be driven by the drive motor.

In the case of a conventional vehicle seat, a drive device is connected to the seat part or to a guide rail arrangement. In this case, for example an output pinion, which is engaged in a tooth segment, is driven by the drive device and in this way exerts an adjusting force on a pivot element. Since the output pinion rolls on the tooth segment, the pivot element and, together therewith, also further pivot elements, are pivoted in the manner of a four-bar linkage, such that the seat height of the seat part is adjusted.

In the case of a vehicle seat known from EP 0 366 364 B1, for example, a pinion is arranged on a side part of a seat part and is in engagement with a tooth segment that is formed integrally on a motion link. For adjusting the height of the vehicle seat, the pinion can be twisted manually, in order to thereby pivot the associated motion link. In addition, the inclination of the seat part can be adjusted by means of an engagement of a pinion, arranged on the motion link, in a tooth segment on a guide rail arrangement.

In the case of a vehicle seat known from U.S. Pat. No. 4,229,041, a seat frame of a seat part is pivotally mounted on a guide rail arrangement. A pinion arranged on the seat frame is in engagement with a tooth segment arranged on the guide rail arrangement, and can be twisted in order to pivot the seat frame relative to the guide rail arrangement, for the purpose of height adjustment of the seat part.

A vehicle seat is known from FR 2503061, in which a seat part is pivotally connected to a guide rail arrangement and can be adjusted in its inclination by means of a pinion that engages in a tooth segment on the guide rail arrangement.

In conventional vehicle seats which use electromotive drives for a height-adjustment apparatus, the drive is arranged for example on the side of the vehicle seat facing a vehicle door, on which there is sufficient installation space available for connecting the drive to the seat part or to the guide rail arrangement. However, if the drive is arranged on what is known as the tunnel side of the vehicle seat, which is located towards the center of the vehicle, the a rigid connection of the drive to the seat part or to the guide rail arrangement is sometimes difficult, because there is less installation space available on this side of the vehicle seat, and in particular an arrangement of the drive on the outside of the seat part or of the guide rail arrangement is not possible. However, arranging the drive on this tunnel side may be desirable if for example a belt connection point for connecting a seatbelt is intended to be provided on the tunnel side of the seat part. In this case, the tunnel side of the vehicle seat is subject to high load forces in the event of a crash, which forces have to be braced and dissipated by the drive device arranged on the tunnel side. The rigidity and crashworthiness requirements for the drive device, by which the driven pivot element and thus the seat part as a whole are held in position, are high in this case and must be configured for the load forces introduced into the seat part, on the tunnel side, via the belt connection point, in the event of a crash.

A drive mechanism for height-adjustment of a vehicle seat is known from DE 101 07 695 A1, in which a spindle is arranged having one end on a spindle nut on the side of a floor assembly in the form of a guide rail, and having another end on a spindle nut on the side of a seat part. The spindle can be twisted by a drive device, in order to thereby adjust the height of the seat part.

In the case of a vehicle seat known from EP 2 337 704 B1, a spindle is pivotally arranged on a lower end of a pivot element. A drive device is arranged on a seat part, wherein the spindle, driven by a drive motor of the drive device, can be moved longitudinally relative to an adjustment gearing, in order to thereby adjust the seat height of the vehicle seat. Another vehicle seat of this kind is known for example from US 2008/0179932 A1.

### SUMMARY

The object underlying the proposed solution is to provide a height-adjustment apparatus for a vehicle seat, in which a drive device can be mounted in a manner requiring little installation space, can in this case meet high rigidity requirements, and furthermore allows for a favorable force profile when the seat part assembly is adjusted for height-adjustment.

This object is achieved by a height-adjustment apparatus with features as described herein.

According thereto, the spindle is pivotally connected to the floor assembly, and the adjustment gearing is arranged so as to be pivotable relative to the pivot element.

This proceeds from providing, in the height-adjustment apparatus, a drive device in the manner of a spindle drive for adjusting the pivot element. The adjustment gearing, which is operatively connected to the spindle and can be driven by the drive motor of the drive device, is pivotable relative to the pivot element. The spindle is in turn pivotally connected to the floor assembly, such driving the adjustment gearing can bring about a change in length of a portion of the spindle extending between the adjustment gearing and the floor assembly, and thereby an adjusting force for pivoting can be introduced into the pivot element.

A drive device of a simple design results, which can furthermore be constructed in a favorable manner in terms of installation space. Since the adjustment gearing (together with the drive motor) is arranged on the pivot element, the adjustment gearing moves together with the pivot element, when the pivot element is pivoted. In this case, the pivotable mounting of the adjustment gearing relative to the pivot element compensates a change in position of the pivot element relative to the floor assembly.

The adjustment gearing can be directly pivotally mounted on the pivot element. However, the adjustment gearing can also be pivotally mounted indirectly relative to the pivot element, for example on an element that is non-rotatably connected to the pivot element and is transversely offset relative to the pivot element.

On account of the comparatively small installation space requirement of the drive device, the drive device can in particular be arranged on the tunnel side of the vehicle seat. This allows in particular for bracing of forces in the region of a belt connection point on the seat part assembly, in particular when the belt connection point is arranged on a frame part of the seat part assembly, and thus on the seat frame of the seat part assembly.

The seat part assembly is typically connected via a plurality of pivot elements to the floor assembly, for example in the form of a longitudinal adjustment apparatus for longitudinal adjustment of the vehicle seat. For example in each case a pair of pivot elements, which, together with the floor assembly and the seat part assembly, in each case for a four-bar linkage, can be arranged on each side of the vehicle seat, i.e. on the door side of the vehicle seat facing the vehicle door, and on what is known as the tunnel side of the vehicle seat, facing towards the vehicle interior. In this case, in one embodiment, the drive device can be arranged for example on just one pivot element, wherein driving the associated pivot element causes the pivot elements to be adjusted in their entirety, in the manner of four-bar linkage pairs, and thus the seat height of the seat part assembly to be adjusted.

The drive device can in particular be arranged on a rear pivot element (with respect to the vehicle longitudinal direction), for example on a rear pivot element associated with the tunnel side.

In one embodiment, the pivot element is pivotally connected to the floor assembly via a first bearing element at a first bearing point and the spindle is pivotally connected to said floor assembly via a second bearing element at a second bearing point that is spaced apart from the first bearing point. Since the spindle is operatively connected to the pivot element via the adjustment gearing, in this way a three-bar linkage is formed, such that a change in the pivot position of the pivot element relative to the floor assembly can be brought about by adjusting the spindle relative to the adjustment gearing. A drive device that is simple in design and has favorable introduction of force into the pivot element results.

In this case, the spindle can comprise an end, on which a bearing point for mounting on the floor assembly is formed. A threaded shank, which is for example in threaded engagement with a spindle nut of the adjustment gearing, extends from the end. The threaded shank can for example extend approximately perpendicularly from the floor assembly, approximately along the vehicle vertical direction. For example, the spindle can be adjustable, relative to the floor assembly, in a comparatively small angular region that encloses the vehicle vertical direction, when the pivot element is adjusted between a lowest seat height and a highest seat height of the seat part assembly. An advantageous, at least approximately uniform, force profile results in the case of adjustment, with favorable support of the pivot element via the spindle. A force profile that has been made uniform furthermore results in favorable acoustics, in particular with non-modulating noise generation.

In one embodiment, the floor assembly comprises a first guide rail and a second guide rail. The first guide rail is guided in a slidable manner on the second guide rail. In this case, the second guide rail is for example fixed on a vehicle floor, and is thus fixed in position relative to the vehicle body. In contrast, the first guide rail is assigned to the seat part assembly and can be moved relative to the second guide rail for adjusting the seat part assembly longitudinally. For coupling to the height-adjustment apparatus, the pivot element and the spindle are in each case pivotally connected to the first guide rail, such that in the case of an adjustment of the first guide rail, the pivot element and the spindle are moved together with the first guide rail.

In this case, the pivot element can be arranged in a hinged manner, indirectly or directly on the first guide rail. For example, an attachment part in the form of a retaining bracket, a frame assembly, or the like, on which the pivot element is pivotally mounted, can be arranged on the first guide rail.

Instead of a first guide rail, an adjustment assembly can also be guided on the second, floor-side guide rail, which assembly, in a manner deviating from a guide rail, is guided on the second, floor-side guide rail for example by means of slides. In this case, the pivot element is for example pivotally mounted on the adjustment assembly.

The pivot element can for example be mounted on an attachment part, which is connected to a base of the first guide rail, for example is butt-welded to the base of the first guide rail. In contrast, the spindle can be mounted for example on a limb extending from the base. The bearing points of the pivot element and of the spindle on the first guide rail are thus spaced apart from one another along a transverse direction corresponding to the vehicle transverse direction.

In one embodiment, the adjustment gearing comprises a gearing assembly and a support part. The gearing assembly is arranged on the support part. In this case, the support part is pivotally connected for example to the pivot element. The gearing assembly can for example be formed by gearing elements, for example a spindle nut and a drive element, for example in the form of a drive worm, which is operatively connected to the spindle nut, wherein the gearing assembly can be enclosed in a gearing housing, for example produced from plastics material. The gearing assembly is for example connected to the pivot element by the support part, wherein for this purpose the support part is for example pivotally mounted on the pivot element.

The support part can be pivotally connected to the pivot element, for pivotable mounting. In addition or alternatively, however, the support part can also be pivotally mounted on an element which is non-rotatably connected to the pivot element (for example via a transverse tube) and is transversely offset relative to the pivot element.

In this case, the mounting of the support part on the pivot element preferably takes place by means of a third bearing element, via which the support part is hingedly connected to the pivot element.

The support part can for example form a component in the manner of a cage, which surrounds the gearing assembly at least in portions. For example, the support part can comprise a first surface portion and a second surface portion, between which the gearing assembly is received. In this case, the surface portions can for example in each case extend in an areal manner, transversely to a longitudinal extension direction of the spindle, such that the gearing assembly is supported relative to the spindle, along the longitudinal extension direction, via the surface portions.

In one embodiment, the support part comprises at least one wall portion which interconnects the first surface portion and the second surface portion and for this purpose extends between the first surface portion and the second surface portion. For example, a plurality of wall portions can be provided, which interconnect different edges of the surface portions, such that a cage for receiving the gearing assembly is created.

In this case, the first surface portion and the second surface portion can be interconnected for example by a welded connection, for example by means of laser welding, resistance welding, MAG welding, or another welding method.

The support part can be formed for example as a metal part, for example from steel, for example manufactured as a stamped and bent part. In this case, wall portions can for example be formed integrally with one of the surface portions. The other surface portion can be connected to the wall portions for example by a welded connection, for forming an integral support part.

In one embodiment, the pivot element comprises an opening into which the support part engages and in which the support part is movable when the pivot element is pivoted. By engagement in the opening, the support part can be (additionally) supported relative to the pivot element, in that the support part can for example come into contact with boundary portions of the pivot element that limit the opening.

In this case, it is conceivable that, in normal operation, the support element is in contact with the boundary portions and is thus supported on the boundary portions. However, it is also conceivable that the support element may come into contact with one or both of the boundary portions only in the event of an exceptional load, for example in the event of a crash, in the case of deformation of the pivot element, in order to in this way provide additional support between the support part and the pivot element.

In one embodiment, the pivot element comprises a wrap-around portion which limits the opening at one side which faces away from the bearing point at which the support part is pivotally mounted on the pivot element. The wrap-around portion thus wraps around the support part on a side facing away from the bearing point. The opening is preferably peripherally closed. Due to the wrap-around portion, the pivot element is formed in a sufficiently stable manner, wherein in particular in the event of a crash the wrap-around portion can provide additional support for the support element relative to the pivot element.

In one embodiment, the height-adjustment apparatus comprises a support element which is arranged on a side of the spindle facing away from the pivot element, in a manner fixed in location relative to the pivot element, and is intended for supporting the adjustment gearing relative to the pivot element. The support element can for example be connected to the pivot element, wherein at least one portion of the support element extends on a side of the spindle facing away from the pivot element, in order to in this way additionally support the adjustment gearing relative to the pivot element.

However, the support element can for example also be connected to a transverse tube, which is pivotally connected to the seat part assembly and carries the pivot element. The transverse tube extends along a transverse direction, for example between side frame parts of the seat part assembly. In this case, the support element is preferably spaced apart from the pivot element, along the transverse direction.

In one embodiment, the support element comprises a support end which can be brought into contact with the adjustment gearing and is intended for supporting the adjustment gearing relative to the pivot element.

A support on the adjustment gearing, in particular in the case of increased load, for example in the event of a crash, can be provided by contact of the support end on the adjustment gearing. In this case, it can be provided that, in a normal use position, i.e. in a state of normal load, for example in the case of a vehicle occupant on the vehicle seat in a normal travel situation of the vehicle, the support end is not in contact with the adjustment gearing. However, in a state of exceptional load, for example in the event of a crash, the support element can come into contact with the adjustment gearing, such that the adjustment gearing is additionally supported on the side of the spindle facing away from the pivot element, by means of the support end in contact with the adjustment gearing, and thereby the seat part assembly can be held secure, and in particular cannot be adjusted in an uncontrolled manner relative to the floor assembly.

The support element can thus be configured such that it can absorb energy in a purposeful manner when supporting the adjustment gearing. The support element can in particular be configured as what is known as a deformation element, which can deform in a manner as intended in the event of a load, and can thus receive and absorb load energy.

In one embodiment, the adjustment gearing comprises a spindle nut which is in threaded engagement with the spindle, and a drive element which can be driven by the drive motor and is operatively connected to the spindle nut. The spindle nut and the drive element can for example form the gearing assembly and can be enclosed for example in a gearing housing which is in turn arranged in or on the support part. Driving of the spindle nut via the drive element—for example in the form of a drive worm having worm toothing, which is in threaded engagement with an external toothing of the spindle nut—causes the spindle nut, which is in threaded engagement with the spindle, to be twisted, and thus to roll on the spindle, such that the spindle is adjusted longitudinally, along its longitudinal extension direction, relative to the adjustment gearing, and thus the length of a portion extending between the adjustment gearing and the end of the spindle that is pivotally mounted on the floor assembly is changed, as a result of which an adjusting force is introduced into the pivot element, for pivoting.

In one embodiment, the spindle is pivotable relative to the floor assembly, about a first pivot axis, and the adjustment gearing is pivotable relative to the pivot element, about a second pivot axis. In this case, the spindle is pivotally mounted on the floor assembly, for example a guide rail or an attachment part connected to the guide rail, via a bearing element. In this case, the adjustment gearing can be pivotally connected to the pivot element indirectly or directly, for example in that the adjustment gearing is mounted on the pivot element or on an element which is non-rotatably connected to the pivot element and is for example transversely offset relative to the pivot element, by means of a bearing element.

In this case, the first pivot axis and the second pivot axis preferably extend in parallel to one another.

The spindle is preferably transversely offset relative to the pivot element, along the first pivot axis, such that the spindle extends to the side of the pivot element, and the spindle and the pivot element are thus pivotable in different planes which extend in parallel with one another and are transversely offset relative to the first pivot axis and to the second pivot axis.

In one embodiment, the adjustment gearing is mounted, so as to be pivotable relative to the pivot element, at a bearing point that is transversely offset relative to the spindle, along the first pivot axis.

In this case, in one embodiment, the adjustment gearing is mounted on one side relative to the pivot element, for example by means of a (single) bearing element directly on the pivot element, or indirectly with respect to the pivot element, on an element that is non-rotatably connected to the pivot element and is transversely offset relative to the pivot element. For the mounting on one side, the bearing point is transversely offset relative to the spindle, along the first pivot axis about which the spindle is pivotally mounted, such that the mounting of the adjustment gearing takes place in a manner transversely offset relative to the longitudinal extension axis of the spindle.

In another embodiment, the adjustment gearing can also be mounted on both sides, by means of two bearing points which are transversely offset relative to one another along the first pivot axis. In this case, a direct mounting on the pivot element can take place via a first bearing point, and in contrast, via a second bearing point that is transversely offset relative to the first bearing point, along the first pivot axis, mounting on an element that is transversely offset relative to the pivot element but is non-rotatably connected to the pivot element, for example via a transverse tube.

According to another aspect, the adjustment assembly for a vehicle assembly comprises a first assembly, a second assembly, a pivot element which is pivotable relative to the first assembly and relative to the second assembly, and a drive device. The drive device is configured to pivot the pivot element in relation to the first assembly in order to adjust the vehicle assembly, wherein the drive device comprises a spindle, a drive motor, and an adjustment gearing which is operatively connected to the spindle and can be driven by the drive motor. In this case, it is provided that the spindle is pivotally connected to the first assembly, and the adjustment gearing is arranged so as to be pivotable relative to the pivot element, wherein the spindle is pivotable relative to the first assembly, about a first pivot axis, and the adjustment gearing is mounted, so as to be pivotable relative to the pivot element, at a bearing point that is transversely offset relative to the spindle, along the first pivot axis.

In one embodiment, the adjustment gearing is pivotable relative to the pivot element, about a second pivot axis, wherein the first pivot axis and the second pivot axis extend in parallel with one another. The pivot element can be pivotable relative to the first assembly, about a third pivot axis, wherein all the pivot axes extend in parallel with one another. An arrangement in the manner of a three-bar linkage results, in which the spindle and the pivot element are pivotally connected to the first assembly, and the adjustment gearing is pivotable relative to the pivot element.

The adjustment gearing can in particular be mounted on one side, relative to the pivot element, via the bearing point. In this case, the bearing point can be arranged directly on the pivot element or on an element that is transversely offset relative to the pivot element, along the first pivot axis, but is non-rotatably connected to the pivot element. An arrangement results in which the adjustment gearing is mounted so as to be pivotable relative to the pivot element, at a bearing point that is transversely offset relative to the spindle. A single arrangement results which is favorable in terms of installation space, and which has effective pivot mounting of the adjustment gearing relative to the pivot element.

In another embodiment, the adjustment gearing can also be mounted on both sides, specifically at a first bearing point on a first side of the spindle, and a second bearing point on a second side of the spindle that faces away from the first side. In this case, the bearing points are transversely offset relative to one another along the first pivot axis, such that the adjustment gearing is mounted at the second bearing point in such a way that the spindle extends through between the two bearing points. An advantageous support of the adjustment gearing on two sides results.

An adjustment apparatus of this kind can in particular be configured as a height-adjustment apparatus for a vehicle seat. However, this is not limiting. An adjustment apparatus of the type described can in principle be configured for adjustment entirely different vehicle assemblies on a vehicle seat or on another assembly in a vehicle.

### BRIEF DESCRIPTION OF THE DRAWINGS

The concept on which the solution is based will be explained in greater detail in the following, with reference to the embodiments shown in the drawings.

FIG. 1 is a schematic view of a vehicle seat comprising a height-adjustment apparatus and a floor assembly in the form of a longitudinal adjustment apparatus.

FIG. 2 is a view of a seat part assembly of a vehicle seat.

FIG. 3 is a plan view of the arrangement according to FIG. 2.

FIG. 4 is an enlarged detail view of the arrangement according to FIG. 2, showing a drive device on a pivot element for connecting the seat part assembly to a floor assembly in the form of a longitudinal adjustment apparatus.

FIG. 5 is a side view of the drive device on the pivot element.

FIG. 6 is a sectional view of the drive device along the line D-D according to FIG. 5.

FIG. 7 is a separate view of the drive device.

FIG. 8 is a sectional view of the arrangement according to FIG. 7, along a cutting line corresponding to the line D-D according to FIG. 5.

FIG. 9 is a perspective view of the drive device.

FIG. 10 is another perspective view of the drive device.

FIG. 11 is a schematic view of a gearing assembly of the drive device.

FIG. 12 is a view of another embodiment of a drive device.

FIG. 13 is a side view of the arrangement according to FIG. 12.

FIG. 14 is a sectional view of yet another embodiment of a drive device.

### DETAILED DESCRIPTION

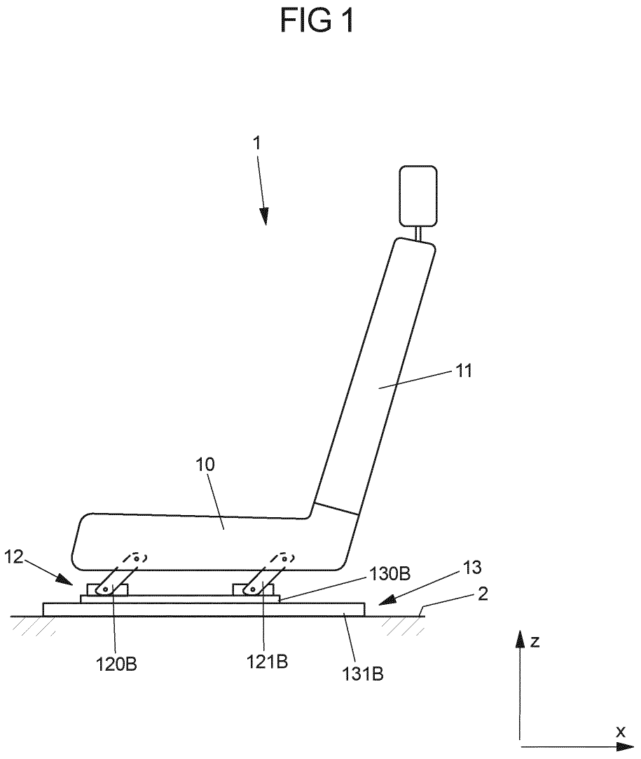

FIG. 1 shows a vehicle seat 1 which can be arranged for example as a front seat or also as a back seat in the second or third seat row in a vehicle. The vehicle seat 1 comprises a seat part assembly 10 on which a backrest part 11 is arranged such that its inclination can be adjusted, and which is connected via a height-adjustment apparatus 12 to a floor assembly 13 in the form of a longitudinal adjustment apparatus for longitudinal adjustment of the vehicle seat 1 along a longitudinal direction X.

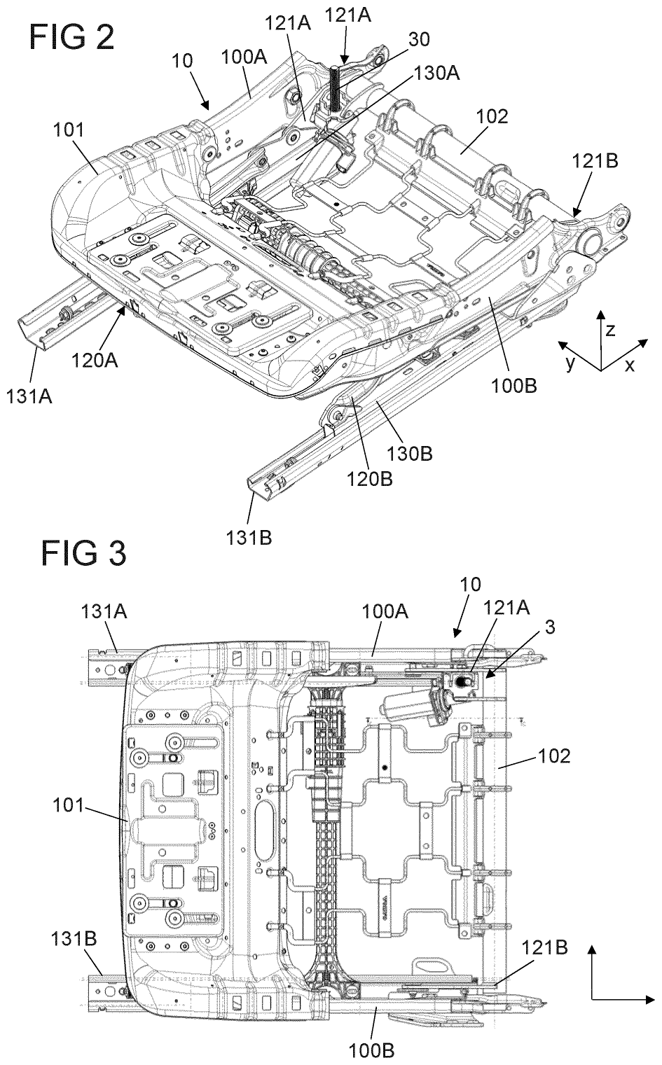

The longitudinal adjustment apparatus 13 typically comprises, as is visible from FIG. 1 in overview with FIGS. 2 and 3, two pairs of guide rails 130A, 131A, 130B, 131B, which are in each case arranged on one side of the seat part assembly 10 and are spaced apart from one another along a transverse direction Y. In this case, lower guide rails 131A, 131B are rigidly connected to a vehicle floor 2. In contrast, upper guide rails 130A, 130B are coupled to pivot elements 120A, 121A, 120B 121B, via which the floor assembly 13 is connected to the seat part assembly 10.

The pivot elements 120A, 121A, 120B, 121B form, together with the upper guide rails 130A, 130B and side frame parts 100A, 100B of the seat part assembly 10, two pairs of four-bar linkages. For this purpose, the pivot elements 120A, 121A, 120B, 121B are in each case pivotally connected by one end to the respectively associated upper guide rail 130A, 130A, and connected by the other end to a transverse tube 102 extending pivotally between the frame parts 100A, 100B of the seat part assembly 10, such that the height position of the seat part assembly 10 can be changed, along a height direction Z, by pivoting the pivot elements 120A, 121A, 120B, 121B.

The frame parts 100A, 100B of the seat part assembly 10 are interconnected at a rear end via the transverse tube 102. The transverse tube 102 is pivotally mounted on the frame parts 100A, 100B and carries the associated, rear pivot elements 121A, 121B.

In a front region, a molded seat 101 is arranged on the frame parts 100A, 100B for forming a seating surface of the seat part assembly 10.

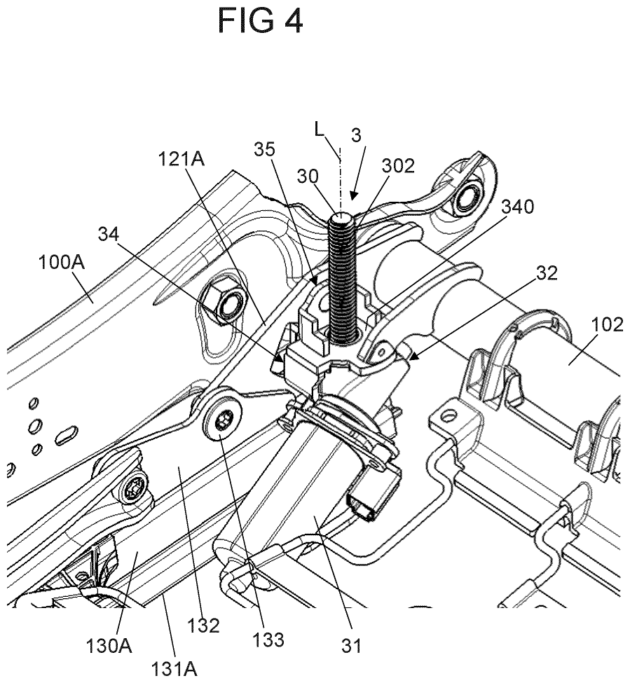

In the embodiment shown, a drive device 3 is arranged on the rear pivot element 121A, on the side of the guide rail pair 130A, 131A, as is visible from FIGS. 2 and 3 in overview with FIG. 4. The drive device 3 is configured as a spindle drive and serves to introduce an adjusting force into the pivot element 121A, such that the pivot elements 120A, 121A, 120B, 121B can all be pivoted, and thus the height position of the seat part assembly 10 can be adjusted, by pivoting the pivot element 121A.

In an adjusted seat height, the seat part assembly 10 is held in position on the pivot element 121A via the drive device 3. For this purpose, the drive device 3 is configured to be loadable to such an extent that forces acting on the seat part assembly 10 can be absorbed and dissipated.

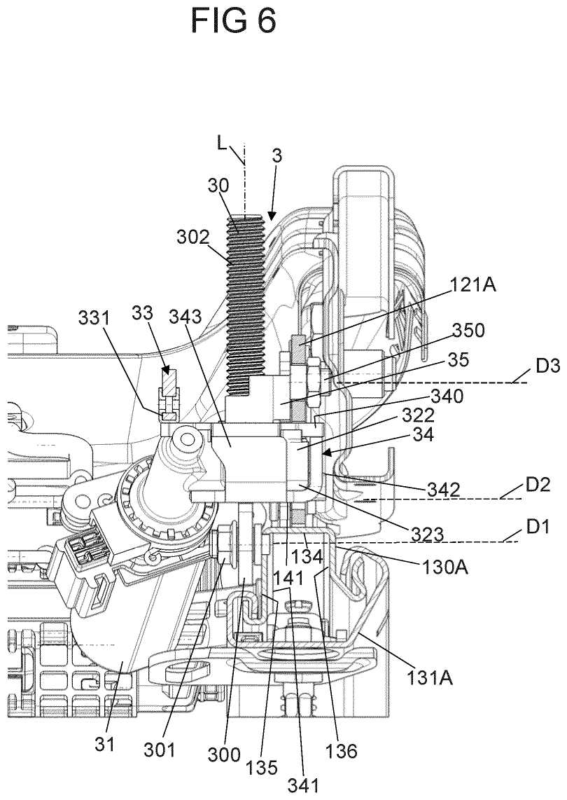

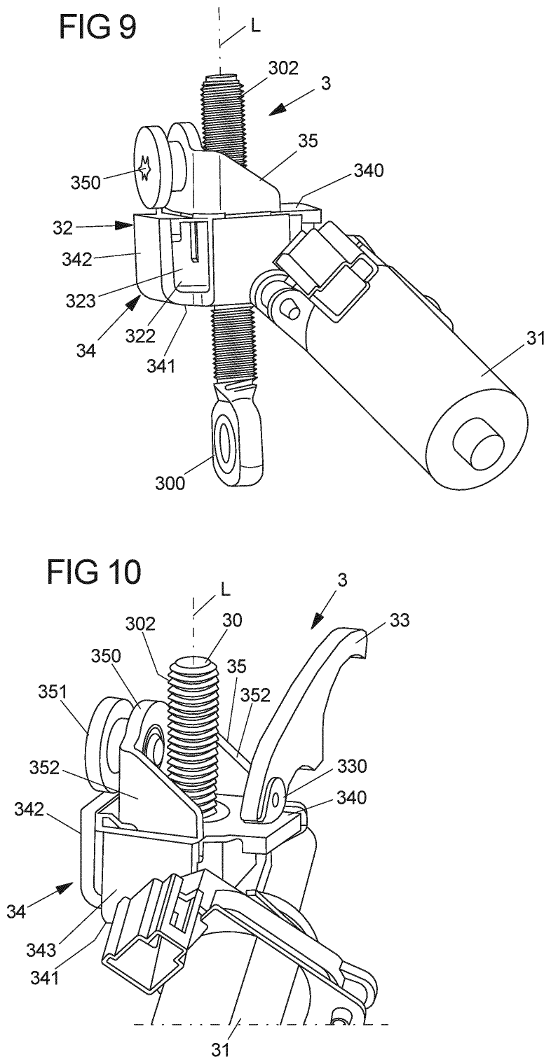

With reference now to FIGS. 4 to 10, the drive device 3 comprises a spindle 30 which is pivotally connected by one end 300, via a bearing element 301, to the associated guide rail 130A. The guide rail 130A comprises a base 134, and side limbs 135, 136 extending from the base 134, as can be seen in particular from FIG. 6. The bearing element 301 is connected to an inner limb 135, for pivotable mounting of the spindle 30 on the guide rail 130A.

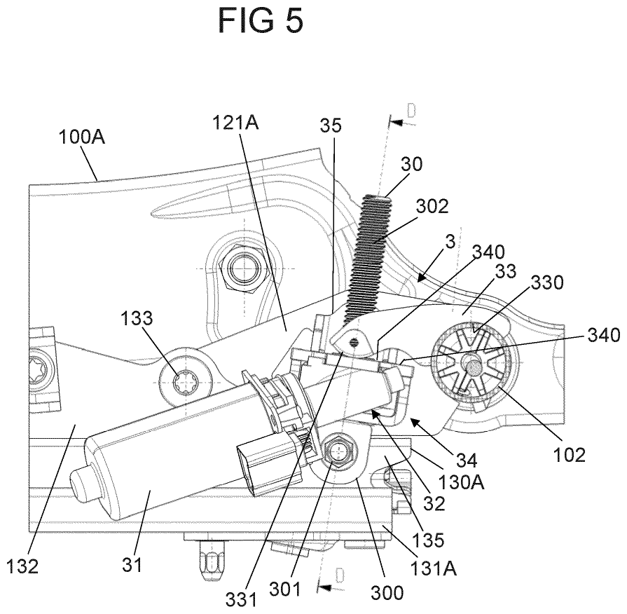

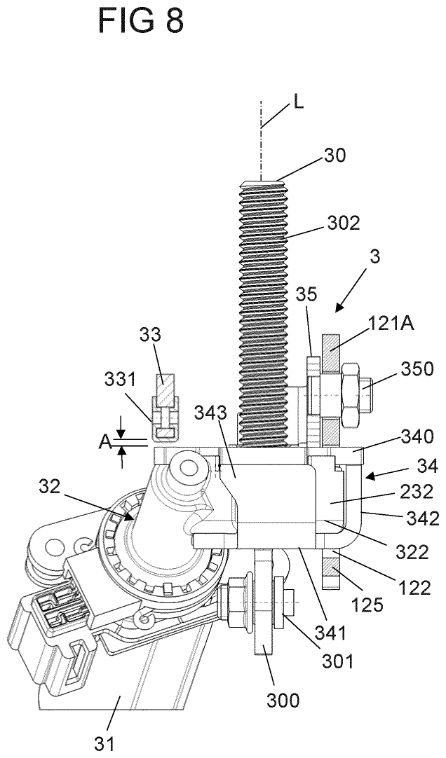

As is visible for example from FIG. 5, the pivot element 121A is coupled to an attachment part 132 that is connected to the base 134 of the guide rail 130A, and is pivotally mounted, via a bearing element 133, on the attachment part 132, and thereby on the guide rail 130A. The bearing elements 133, 301 for mounting the pivot element 121A and the spindle 30 are spaced apart from one another along the longitudinal direction X and also along the height direction Z, wherein there is additionally an offset along the transverse direction Y, between the bearing points that mount the spindle 30 and the pivot element 121A, as follows in particular from FIGS. 6 and 8.

The spindle 30 extends substantially perpendicularly from the end 300, by a threaded shank 302 on which a thread is formed. A gearing assembly 322 of an adjustment gearing 32 is operatively connected to the spindle 30 in such a way that the adjustment gearing 32 can be adjusted, relative to the spindle 30, along a longitudinal extension direction L, by the gearing assembly 322 being driven, in order to in this way change the length of a between the adjustment gearing 32 and the end 300 of the spindle 30 that is pivotally mounted on the guide rail 130A, and thereby introduce an adjusting force into the pivot element 121A.

As is shown schematically in FIG. 11, the gearing assembly 322 comprises a spindle nut 321, and a drive element 320 in the form of a drive worm, which is in toothed engagement with an external toothing of the spindle nut 321 via a worm toothing. The drive element 320 is driven by a drive motor 31, such that the spindle nut 321 can be caused to perform a rotational movement, by means of the drive motor 31. The spindle nut 321 is in threaded engagement, via an internal thread, with an external thread of the spindle 30 in such a way that, by means of twisting, the spindle nut 321 rolls on the spindle 30 and as a result is adjusted longitudinally, along the longitudinal direction L, relative to the spindle 30.

The gearing assembly 322 comprises a gearing housing 323 in which the kinematics components of the gearing assembly 322, specifically the spindle nut 321 and the drive worm 320, are enclosed.

The gearing assembly 322 is received on a support part 34 in the form of a cage element which comprises surface portions 340, 341 that extend in each case transversely to the longitudinal extension direction L of the spindle 30. Wall portions 342, 343, which interconnect the surface portions 340, 341, extend between the surface portions 340, 341.

In this case, the wall portions 342, 343 are formed for example integrally with the surface portion 341, by bending, and for example are in each case connected to the surface portion 340 via a welded connection.

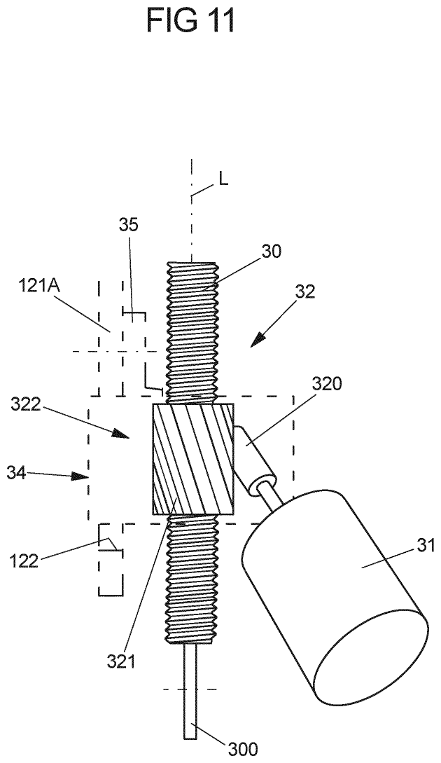

A connecting element 35 is fixedly arranged on the surface portion 340, which connecting element is pivotally mounted on the pivot element 121A via a bearing element 350. The connecting element 35 is formed in the manner of a retaining bracket, and comprises a base 351, and limbs 352 extending from the base 351 (see in particular FIG. 10). The base 351 extends in an areal manner and in parallel with the pivot element 121A, and is connected to the bearing element 350 for pivotally mounting the adjustment gearing 32 on the pivot element 121A. In contrast, the limbs 352 extend on both sides of the spindle 30 and establish the connection to the support part 34.

The adjustment gearing 32 is pivotally mounted on the pivot element 121A via the support part 34 and the connecting element 35. In the case of an adjustment movement in which the length of the portion of the spindle 30 extending between the adjustment gearing 32 and the end 300 is changed, the adjustment gearing 32 can thus pivot at the pivot element 121A, in order to thereby compensate a change in position of the pivot element 121A relative to the floor assembly 13.

The drive motor 31 is connected to the support part 34 via the adjustment gearing 32, and thus pivotally mounted on the pivot element 121A. In the case of an adjusting movement of the pivot element 121A, the drive motor 31 and also the adjustment gearing 32 are thus moved together with the pivot element 121A.

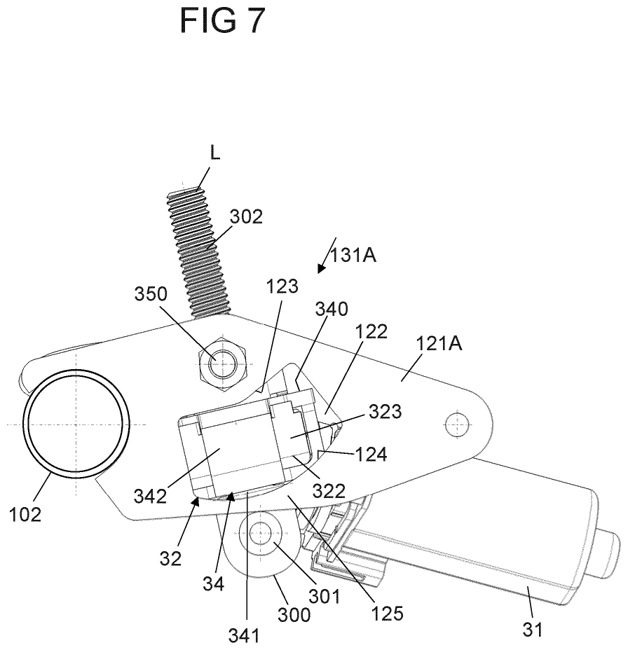

In the embodiment shown, the support part 34 rests in an opening 122 of the pivot element 121A, as is clear in particular from FIG. 7. In this case, the surface portion 340 faces an upper boundary portion 123 that limits the opening 122, while the surface portion 341 faces a lower boundary portion 124. In the case of an adjusting movement, the support part 34 is moved in the opening 122.

An (additional) support of the support part 34 relative to the pivot element 121A can be provided by the boundary portions 123, 124, wherein it is possible to provide, for example, that the support part 34 is not in contact, by its surface portions 340, 341, with the boundary portions 123, 124 in a normal use position, and thus undesired noise generation due to rubbing does not occur in the event of an adjusting movement. In a state of exceptional load, for example in the event of a crash, the support part 34 can, however, come into contact with one or both of the boundary portions 123, 124, in order to in this way support the support part 34, and thereby the adjustment gearing 32, on the pivot element 121A.

Under the support part 34, the pivot element 121A forms a wrap-around portion 125 which wraps around the support part 34 on the side of the surface portion 341. The opening 122 is thus peripherally closed. Via the wrap-around portion 125, a crash-safe support of the support part 34 relative to the pivot element 121A can be provided, wherein the pivot element 121A can, in the event of a crash, deform for example in the region of the wrap-around portion 195, and thus the pivot element 121A can come into contact with the support part 34 in a supporting manner.

The pivot element 121A is arranged on the transverse tube 102 that is pivotally arranged between the frame parts 100A, 100B, and in addition is rigidly connected to the transverse tube 102, such that the transverse tube 102 is pivoted relative the frame parts 100A, 100B in the case of pivoting of the pivot element 121A. As is also evident from the enlarged view according to FIG. 4, in this case in addition a support element 33 is arranged on the transverse tube 102, which serves for supporting the adjustment gearing 32 relative to the transverse tube 102 and thus relative to the pivot element 121A, on a side of the spindle 30 facing away from the pivot element 121A.

As is visible from FIG. 5, the support element 33 forms a connecting portion 330 which is rigidly connected to the transverse tube 102. A support end 331 is at a distance from the transverse tube 102, and is configured to come into contact with the upper surface portion 340 of the support part 34, in order to in this way provide (additional) support of the adjustment gearing 32 relative to the pivot element 121A.

As is clear from FIG. 8, it can be provided that the support end 331 is at a distance A from the surface portion 240 of the support part 34 in a normal use position. In a state of exceptional load, for example in the event of a crash, the support end 331 can, however, come into contact with the surface portion 340, in order to in this way provide support for the adjustment gearing 32. The adjustment gearing 32 is thus supported on both sides of the spindle 30, on one side by the pivot element 121A and on the other side by the support element 33, and is thus held in position, relative to the transverse tube 102, in a crash-safe manner.

In the embodiment described above, the adjustment gearing 32 is mounted on the pivot element 121A on one side, via the connecting element 35 that is connected to the support part 34. In this case, the spindle 30 is mounted on the guide rail 130A about a pivot axis D1, the pivot element 121A is mounted on the guide rail 130A about a pivot axis D2, and the connecting element 35 is mounted (directly) on the pivot element 121A via the bearing element 350, about an associated pivot axis D3. The pivot axes D1, D2, D3 extend in parallel with one another, as is illustrated for example in FIG. 7, such that an arrangement in the manner of a three-bar linkage results.

The spindle 30 is transversely offset relative to the pivot element 121A, along the first pivot axis D1. The pivot element 121A and the spindle 30 are thus pivotable in planes that are mutually parallel and are transversely offset relative to one another, along the pivot axes D1, D2, D3, such that the spindle 30 extends in a manner laterally offset relative to the pivot element 121A and can be adjusted in a transversely offset manner relative to the pivot element 121A.

In this case, a bearing point formed by the bearing element 350 on the pivot element 121A is transversely offset relative to the spindle 30, along the pivot axis D1. The mounting on one side results in a design that is favorable with respect to installation space and in which additional support can be provided by the support element 33 in a state of exceptional load, in particular in the event of a crash.

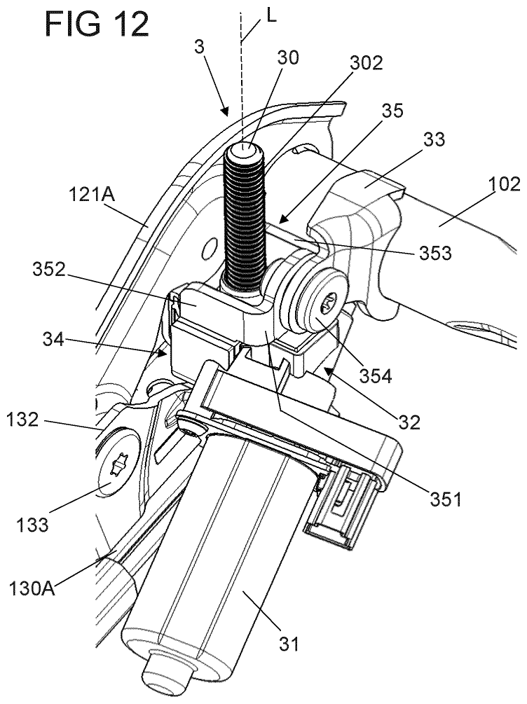

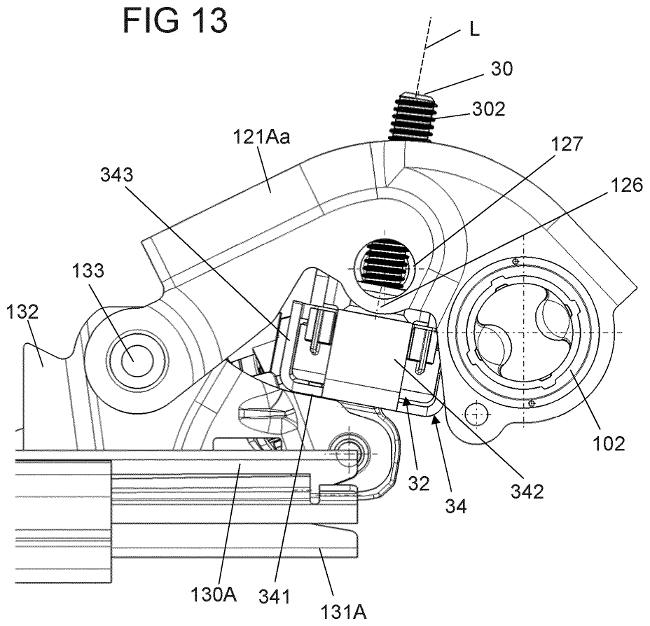

In another embodiment shown in FIGS. 12 and 13, the adjustment gearing 32 enclosed in the support part 34 is not directly mounted on the pivot element 121A, via the connecting element 35, but rather on a support element 33 that is transversely offset relative to the pivot element 121A, via a base 353 of the connecting element 35 and a bearing element 354 arranged thereon. Again, a one-sided mounting of the adjustment gearing 32 results, but not directly on the pivot element 121A but rather on the support element 33 that is transversely offset relative to the pivot element 121A and is non-rotatably connected to the pivot element 121A via the transverse tube 102.

As is clear from FIG. 13, in this embodiment additional support in a state of exceptional loading, in particular in the event of a crash, can be provided by the pivot element 121A. For this purpose, the pivot element 121A forms a support portion 126, which limits a deformation opening 127 and is cut free from areally extending, further portions of the pivot element 121A via the deformation opening 127.

Via the support portion 126, the pivot element 121A provides support for the adjustment gearing 32 in a state of exceptional load, in that the support part 34 can come into contact with the support portion 126. In this case, the support portion 126 can be deformable in the manner of a deformation element, such that load energy can be received and absorbed at the support portion 126.

In a normal operating state, the support portion 126 is preferably spaced apart from the support part 34, such that there is no contact between the support portion 126 and the support part 34.

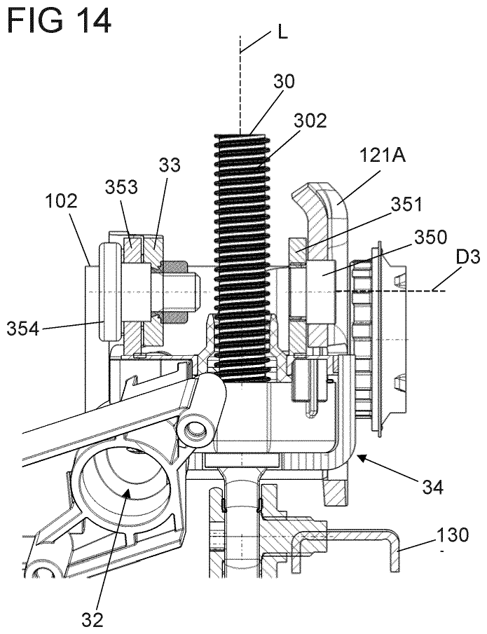

In yet another embodiment shown in FIG. 14, the adjustment gearing 32 is mounted on both sides, via two bearing points, relative to the pivot element 121A, in that the connecting element 35 is pivotally connected to the pivot element 121A, via a first bearing element 350, on a first base 351, and is pivotally connected to the support element 33, via a second bearing element 354, on a second base 353, and thus mounting for the adjustment gearing 32 takes place on both sides of the spindle 30. In this case, the bearing points provided by the bearing elements 350, 354 are transversely offset from one another along the pivot axis D3 and arranged on different sides of the spindle 30. An advantageous, symmetrical force absorption and support results during operation.

Aside from the mounting of the adjustment gearing 32 relative to the pivot element 121A, the embodiments according to FIGS. 12, 13 and FIG. 14 are functionally identical to the embodiment described with reference to FIGS. 4 to 10, and therefore reference is made to the above explanations.

The concept on which the solution is based is not limited by the embodiments set out above, but rather can also be implemented in another manner.

On a vehicle seat, a (single) pivot element of a height-adjustment apparatus can be driven by an associated drive device of the type described. However, it is also conceivable to drive more than one pivot element by one associated drive device in each case.

A vehicle seat of the described type can form a front seat in a vehicle but can also form a vehicle seat in the second or third seat row.

### LIST OF REFERENCE SIGNS

1 vehicle seat
10 seat part assembly
100A, 100B frame part
101 molded seat
102 transverse tube
11 backrest part assembly
12 height-adjustment apparatus
120A, 120B pivot element (motion link)
121A, 121B pivot element (motion link)
122 opening
123, 124 boundary portion
125 wrap-around portion
126 support portion
127 deformation opening
13 floor assembly (longitudinal adjustment apparatus)
130A, 130B guide rail
131A, 131B guide rail
132 attachment part
133 bearing bolt
134 base
135, 136 limb
2 vehicle floor
3 adjustment drive
30 spindle
300 end
301 bearing element
302 threaded shank
31 drive motor
32 adjustment gearing
320 drive element (drive worm)
321 spindle nut
322 gearing assembly
323 gearing housing
33 support element
330 connecting portion
331 support end
34 support part (gearing cage)
340 surface portion
341 surface portion
342, 343 wall portion
35 connecting element
350 bearing element
351 base
352 limb
353 base
354 bearing element
A distance
D1, D2, D3 pivot axis
L longitudinal extension direction
X longitudinal direction
Y transverse direction
Z height direction

1. A height-adjustment apparatus of a vehicle seat, comprising
a floor assembly,
a seat part assembly,
a pivot element, which is pivotable in relation to the floor assembly and to the seat part assembly, and
a drive device which is configured to pivot the pivot element in relation to the floor assembly in order to adjust a seat height of the seat part assembly, wherein the drive device comprises a spindle, a drive motor, and an adjustment gearing which is operatively connected to the spindle and can be driven by the drive motor,
wherein the spindle is pivotally connected to the floor assembly, and the adjustment gearing is pivotally arranged relative to the pivot element.

2. The height-adjustment apparatus according to claim 1, wherein the pivot element is pivotally connected to the floor assembly via a first bearing element at a first bearing point and the spindle is pivotally connected to said floor assembly via a second bearing element at a second bearing point that is spaced apart from the first bearing point.

3. The height-adjustment apparatus according to claim 1, wherein the spindle comprises an end and a threaded shank extending away from the end, wherein the end is pivotally connected to the floor assembly and the adjustment gearing is operatively connected to the threaded shank.

4. The height-adjustment apparatus according to claim 1, wherein the floor assembly comprises a first guide rail and a second guide rail, wherein the first guide rail is guided in a sliding manner on the second guide rail and the pivot element and the spindle are each pivotally connected to the first guide rail.

5. The height-adjustment apparatus according to claim 1, wherein the adjustment gearing comprises a gearing assembly and a support part, on which the gearing assembly is arranged and which is pivotally connected to the pivot element.

6. The height-adjustment apparatus according to claim 5, wherein the support part is pivotally mounted on the pivot element by a third bearing element.

7. The height-adjustment apparatus according to claim 5, wherein the support part comprises a first surface portion and a second surface portion, wherein the gearing assembly is received between the first surface portion and the second surface portion.

8. The height-adjustment apparatus according to claim 7, wherein at least one of
the first surface portion and the second surface portion are each directed transversely to a longitudinal extension direction along which the spindle extends in an elongate manner and
the support part comprises at least one wall portion that interconnects the first surface portion and the second surface portion.

9. (canceled)

10. The height-adjustment apparatus according to claim 5, wherein the pivot element comprises an opening into which the support part engages and in which the support part is movable when the pivot element is pivoted.

11. (canceled)

12. The height-adjustment apparatus according to claim 1, further comprising a support element, which is arranged stationary relative to the pivot element on a side of the spindle facing away from the pivot element, for supporting the adjustment gearing relative to the pivot element.

13. The height-adjustment apparatus according to claim 12, wherein at least one of
the pivot element is connected to a transverse tube which is pivotable relative to the seat part assembly and extends along a transverse direction, wherein the support element is connected to the transverse tube and is spaced apart from the pivot element along the transverse direction, and
the support element comprises a support end, which can be brought into contact with the adjustment gearing, for supporting the adjustment gearing relative to the pivot element.

14. (canceled)

15. (canceled)

16. The height-adjustment apparatus according to claim 1, wherein the adjustment gearing comprises a spindle nut which is in threaded engagement with the spindle, and a drive element which can be driven by the drive motor and is operatively connected to the spindle nut.

17. The height-adjustment apparatus according to claim 1, wherein the spindle is pivotable about a first pivot axis relative to the floor assembly and the adjustment gearing is pivotable about a second pivot axis relative to the pivot element, wherein the first pivot axis and the second pivot axis extend in parallel to one another.

18. The height-adjustment apparatus according to claim 17, wherein at least one of
the spindle is transversely offset relative to the pivot element along the first pivot axis and
the adjustment gearing is mounted at a bearing point so as to be pivotable relative to the pivot element, which bearing point is transversely offset relative to the spindle along the first pivot axis.

19. (canceled)

20. (canceled)

21. The height-adjustment apparatus according to claim 17, wherein the adjustment gearing is pivotally mounted relative to the pivot element at two bearing points that are transversely offset relative to one another along the first pivot axis, wherein a first of the two bearing points is arranged on a first side of the spindle, and a second of the bearing points is arranged on a second side of the spindle facing away from the first side.

22. An adjustment apparatus for a vehicle assembly, comprising
a first assembly,
a second assembly,
a pivot element, which is pivotable relative to the first assembly and to the second assembly, and
a drive device, which is configured to pivot the pivot element relative to the first assembly in order to adjust the vehicle assembly, wherein the drive device comprises a spindle, a drive motor, and an adjustment gearing which is operatively connected to the spindle and can be driven by the drive motor,
wherein the spindle is pivotally connected to the first assembly, and the adjustment gearing is arranged so as to be pivotable relative to the pivot element, wherein the spindle is pivotable about a first pivot axis relative to the first assembly and the adjustment gearing is pivotally mounted relative to the pivot element at a bearing point that is transversely offset relative to the spindle along the first pivot axis.

23. The adjustment apparatus according to claim 22, wherein the adjustment gearing is pivotable relative to the pivot element about a second pivot axis and the first pivot axis and the second pivot axis extend in parallel to one another.

24. The adjustment apparatus according to claim 22, wherein the bearing point is arranged on the pivot element or on an element that is transversely offset relative to the pivot element along the first pivot axis.

25. The adjustment apparatus according to claim 22, wherein the adjustment gearing is pivotally mounted relative to the pivot element at two bearing points that are transversely offset relative to one another along the first pivot axis, wherein a first of the two bearing points is arranged on a first side of the spindle, and a second of the bearing points is arranged on a second side of the spindle facing away from the first side.

26. The adjustment apparatus according to claim 22, wherein the adjustment apparatus is a height-adjustment apparatus of a vehicle seat.
